(19) United States
(12) Patent Application Publication
(10) Pub. No.: US 2005/0136384 A1
(43) Pub. Date: Jun. 23, 2005

(54) Device and method for promoting effective oral hygiene by a child

(76) Inventor: Terese Ann Jarvis, Bend, OR (US)

Correspondence Address: ANDREW F. KNIGHT, 6330 COLUMBIA PIKE, FALLS CHURCH, VA, 22041, US

(21) Appl. No.: 11/038,392

(22) Filed: Jan. 21, 2005

(51) Int. Cl. G09B 23/28

(52) U.S. Cl. 434/263

(57) ABSTRACT

A device for promoting effective oral hygiene by a child includes a base, a model of a set of teeth connected to the base, an indicator connected to the model or the base and configured to indicate a first subset of the set of teeth, and a processor connected to the indicator. The processor is configured to cause the indicator to indicate the first subset to thereby instruct the child to brush the child's teeth corresponding to the first subset, and to cause the indicator to subsequently indicate a second subset of the set of teeth, different from the first set, to thereby instruct the child to brush the child's teeth corresponding to the second subset. The first subset corresponds to a first recommended tooth-brushing zone of the child's mouth and the second subset corresponds to a second recommended tooth-brushing zone of the child's mouth.

### BACKGROUND

Proper methods for effective oral hygiene are well known, but are rarely used by most adults. Such methods are more likely to be used where the adult is properly trained as a child, whereby good oral hygiene habits are more easily formed. Children are, however, easily distracted—thus, a device is needed for demonstrating and promoting effective oral hygiene to a child, particularly one that is easy to use, maintains the child's attention, and encourages the child to continue to promote the child's oral hygiene.

U.S. Pat. No. 3,771,227 to Black discloses a dental care demonstration device. U.S. Pat. No. 4,934,940 to Savery discloses a dental hygiene instructional display using a humanoid figure providing a facial expression exhibiting representations of human teeth. U.S. Pat. No. 5,810,601 to Williams discloses a dental hygiene display for instructing and educating children on proper toothbrush stroke technique, brushing duration, and stroke location. U.S. Pat. No. 5,944,531 to Foley et al. discloses an oral hygiene instructional display of a human mouth including a body, an upper arch comprised of a representation of a plurality of teeth, a lower arch comprised of a plurality of teeth, a timer, and an audible source. Regarding feedback information on oral hygiene, U.S. Pat. No. 4,253,212 to Fujita discloses a sound emitting device and/or a light emitting device actuated by brushing movement, provided in the stem of a tooth brush, that sense the reciprocating motion and the rotational motion of the brush, and the pressure applied on brushing, and U.S. Patent No. 6,536,068 to Yang et al. discloses Devices and systems for monitoring toothbrushing technique.

However, none of these devices demonstrates and promotes effective oral hygiene to a child, with an aim toward ease of use, maintaining the child's attention, and encouraging the child to continue to promote the child's oral hygiene.

### SUMMARY OF THE INVENTION

The present invention aims to solve at least one of these and other problems.

In one embodiment of the present invention, a device for promoting effective oral hygiene by a child comprises: a base; a model of a set of teeth connected to the base; an indicator connected to at least one of the model and the base and configured to indicate a first subset of the set of teeth; and a processor connected to the indicator and configured to cause the indicator to indicate the first subset to thereby instruct the child to brush the child's teeth corresponding to the first subset, and to cause the indicator to subsequently indicate a second subset of the set of teeth, different from the first set, to thereby instruct the child to brush the child's teeth corresponding to the second subset, wherein the first subset corresponds to a first recommended tooth-brushing zone of a mouth of the child and the second subset corresponds to a second recommended tooth-brushing zone of the mouth of the child.

In one aspect, the device further comprises a frame to which the base is connected, wherein the frame has a shape of a human head and has a facial appearance representing a face of a human athlete.

In one aspect, the device further comprises a microphone connected to the processor, wherein the processor is programmed to recognize a voice sound input via the microphone as an instruction to the processor.

In one aspect, the device further comprises an information output connected to the processor, the information output comprising at least one of a display, a lamp, and a speaker, wherein the processor is configured to, after a successful completion of an oral hygiene demonstration by the device, indicate to the child via the information output that the child has earned a prize. The processor may be configured to indicate to the child that the child has earned a prize after some but not all successful completions of the oral hygiene demonstration. The prize may be intangible, such as winning “first place,” “rank of toothbrushing lieutenant,” “black belt toothbrusher,” scoring additional points in a fictitious game (such as two additional points in a fictitious basketball game against the “Cavities”), etc.

In one aspect, the device further comprises a timer connected to the processor, wherein the processor is configured to cause the indicator to indicate the second subset a predetermined time after causing the indicator to indicate the first subset, based at least in part on a timing of the timer. The predetermined time may be between approximately 20 and 40 seconds, and preferably between approximately 30 and 35 seconds.

In one aspect, the processor is configured to cause the indicator to indicate spaces between pairs of adjacent teeth of the set of teeth to thereby instruct the child to floss between the child's teeth corresponding to the spaces. In one aspect, the device further comprises a clock connected to the processor, wherein the processor is configured to cause the indicator to instruct the child to floss not more than once per day, based at least in part on a signal from the clock.

In one aspect, the device further comprises a tongue model connected to the base, wherein the processor is configured to cause the indicator to indicate the tongue model to thereby instruct the child to brush the child's tongue.

In one aspect, the device is water-resistant, whereby the model may be brushed with a wet toothbrush without damaging the device.

In one aspect, the device further comprises a speaker connected to the processor, wherein the processor is programmed to create sounds via the speaker. The sounds may comprise music, and/or may comprise a representation of a voice providing instructions to a child regarding effective oral hygiene, and/or may comprise a representation of a voice providing at least one of: a tip regarding oral hygiene; a fact regarding a human mouth; a joke; and a story. The processor may be programmed to create at least a portion of the sounds after a successful completion of an oral hygiene demonstration by the device as a reward to the child. In one aspect, the device further comprises an input connected to the processor and configured to allow a user to input a personalization into the processor, wherein the sounds are personalized with respect to the child.

In one aspect, the device further comprises a toothbrush remotely connected to the processor, wherein the toothbrush is configured to provide a feedback signal to the processor, and wherein the instructions are selected based at least in part on the feedback signal.

In one aspect, the device further comprises at least one sensor connected to the processor and the first subset, wherein the at least one sensor is configured to convert a tooth-brushing of the first subset into a feedback signal to the processor, and wherein the instructions are selected based at least in part on the feedback signal.

In one aspect, the device further comprises a speaker connected to the processor, wherein the processor is programmed to create sounds via the speaker, wherein the sounds comprise a representation of a voice providing instructions to a child regarding rinsing with mouthwash.

In one aspect, the processor is configured to cause the indicator to indicate a brushing movement within the first subset, such as by using blinking lights to indicate brushing. The indicator may comprise an arrowed circle graphic which, when illuminated, indicates a brushing movement within the first subset. The indicator may comprise a plurality of lamps, independently illuminatable by the processor, which when illuminated successively indicate a brushing movement within the first subset.

In one aspect, the base is hinged to allow the model of teeth to close in a manner corresponding to a closing a human mouth. The base may be substantially permanently flat. The device may have a shape of a substantially flat plate. In one aspect, the device further comprises, connected to the base, at least one of: a toothbrush holder; a toothpaste holder; a rinse cup; and a floss bay. The device may be configured to be attached to at least one of a wall and a mirror via at least one of a hanging nail and suction cups, respectively.

In one aspect, the indicator is configured to indicate the first subset of the set of teeth at least in part by a mechanical movement of the first subset. The indicator may be configured to indicate the first subset of the set of teeth by a mechanical movement of a toothbrush indicator movable along the model. The indicator may comprise: a lamp configured to provide a focused illumination on the model; and an actuator configured to aim the focused illumination from the first subset to the second subset based at least in part on an instruction received from the processor.

In one aspect, the indicator comprises a plurality of lamps, independently illuminatable by the processor, in each of the first and second subsets of teeth. The plurality of lamps in the each subset may comprise at least two lamps: a first lamp corresponding to an inner area of the each subset; and a second lamp corresponding to an outer area of the each subset. The plurality of lamps in the each subset may further comprise a third lamp corresponding to at least one of a middle area of the each subset and a whole area of the each subset. The first subset may comprise a plurality of the set of teeth, wherein the plurality of lamps in the first subset further comprises at least one flossing lamp for and corresponding to each space between pairs of adjacent teeth of the plurality of the set of teeth. The processor may be configured to perform the following steps at different times: illuminate the first lamp of the first subset; illuminate the second lamp of the first subset; illuminate the first lamp of the second subset; illuminate the second lamp of the second subset; and illuminate at least one of the flossing lamps of the first subset.

In one aspect, the processor is configured to cause the indicator to indicate, at different times, exactly three distinct subsets of an upper region of the set of teeth and exactly three distinct subsets of a lower region of the set of teeth. The processor may be configured to cause the indicator to indicate, at different times and for each of the distinct subsets, at least an inner area and an outer area of the each subset. Each of the distinct subsets may be colored differently.

In one aspect, the processor is capable of operation in at least a normal mode and a random mode, wherein in the normal mode the processor is configured to indicate the distinct subsets in a predetermined order, and wherein the random mode the processor is configured to indicate the distinct subsets in a random order.

In one aspect, the set of teeth protrude from the base to represent actual human teeth protruding from gums. The set of teeth may comprise exactly 20 teeth, whereby the model represents a human child's set of teeth.

According to another embodiment of the present invention, a method for promoting effective oral hygiene by a child comprises: providing the device as described; and encouraging a child to operate the device, wherein the device is configured to provide a positive reinforcement to the child after a successful completion of an oral hygiene demonstration by the device.

According to another embodiment of the present invention, a method for promoting effective oral hygiene by a child comprises: providing the device as described; and encouraging a child to operate the device, wherein the device is configured to execute an oral hygiene demonstration that includes at least one of the following: instructing the child to rinse with mouthwash; instructing the child to floss; and instructing the child to brush the child's tongue.

According to another embodiment of the present invention, a method for promoting effective oral hygiene by a child comprises: providing the device as described; encouraging a child to operate the device; and encouraging the child to brush the set of teeth.

According to another embodiment of the present invention, a method for promoting effective oral hygiene by a child comprises: providing the device as described; providing a video for instructing a child on effective oral hygiene; showing the video to the child; encouraging the child to operate the device; and encouraging the child to execute effective oral hygiene based on instructions from both the video and the device.

### BRIEF DESCRIPTION OF THE DRAWINGS

FIG. 1 shows a front view of a device according to one embodiment of the present invention.

FIG. 2 shows a perspective view of a device according to another embodiment of the present invention.

FIG. 3 shows a front view of a device according to another embodiment of the present invention.

FIG. 4 shows a schematic of a circuit utilized by a device according to an embodiment of the present invention.

### DETAILED DESCRIPTION

In the following description, the use of“a,” “an,” or “the” can refer to the plural. All examples given are for clarification only, and are not intended to limit the scope of the invention.

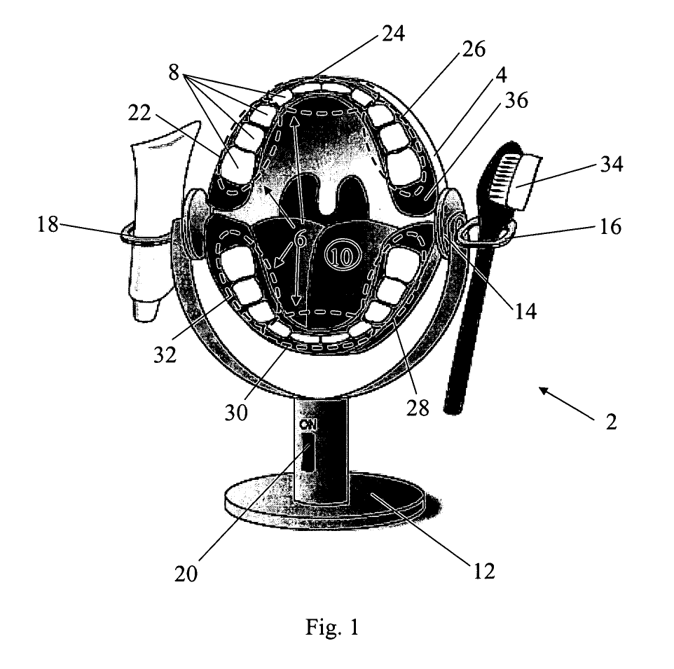

Referring now to FIG. 1, a device 2 according to one embodiment, which may be called My Brushing Buddy™, comprises a base 4, a model 6 of a set of teeth 8 and a tongue 10 connected to the base 4, a gum region 36 connected to the base 4, a stand 12 connected to the base 4 via a swivel 14 so that the base 4 may rotate with respect to the stand 12, a toothbrush holder 16 configured to hold a toothbrush 34, a toothpaste holder 18, and a switch 20. The set of teeth 8 may be broken into a plurality of subsets or brushing zones 22, 24, 26, 28, 30, 32.

The base 4 may be a substantially flat plate, may be contoured (as examples: to take the shape or contour more closely resembling that of a human mouth; connected to a raised or protruding gum region 36 corresponding to gums of a human mouth; etc.), and/or may be hinged to allow opening and closing in a manner similar to the opening and closing of a human mouth. The base 4, gum region 36, set of teeth 8, and tongue 10 may comprise any solid material, such as plastic, metal, ceramic, glass, etc., and may include a compressible material (e.g., rubber, spongy material, polymer, etc.) to more accurately represent the texture of a human mouth (e.g., spongy gums and tongue of a human mouth, hard enameled teeth of a human mouth, and so forth).

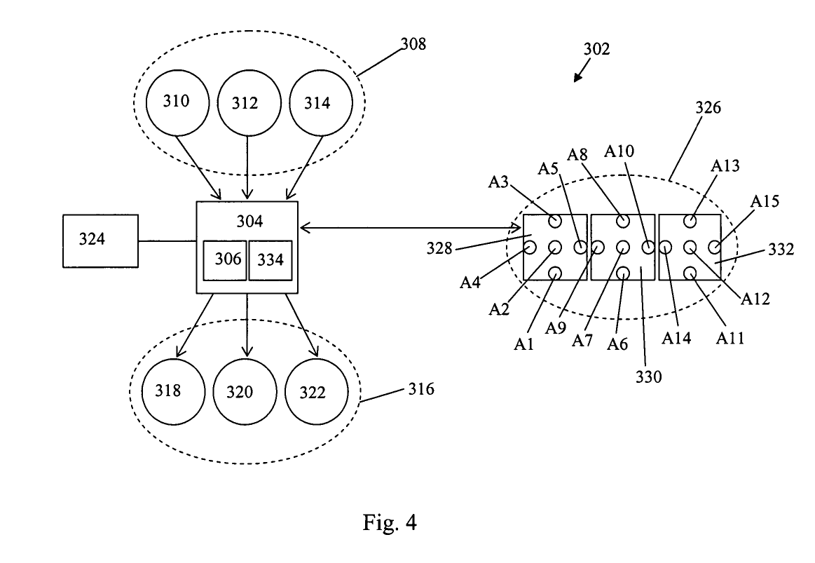

The set of teeth 8 may be flush with the base 4 and/or gum region 36, or may protrude partially or fully (where “fully” corresponds to the manner in which actual human teeth protrude from human gums). The set of teeth 8 may or may not be divided into six (or eight or other number) zones 22, 24, 26, 28, 30, 32, which correspond to recommended tooth-brushing zones of a child's mouth. The zones 22-32 may be colored differently and/or may include lamps (discussed later with respect to FIG. 4) that provide differently colored illuminations so as to help a child to more easily differentiate between the various recommended brushing zones.

Alternatively or in addition, the zones 22-32 may be configured to physically move in response to an instruction from a processor (discussed later), such as the vibrate, raise up and down within surrounding gum region 36, wave back and forth, and so forth. One of ordinary skill in the art will recognize many of the multitude of ways in which each of zones 22-32 may be made to physically move in the desired way. For example, to cause zone 22 to raise upward from being otherwise flush with surrounding gum region 36, an electromagnet located within zone 22 may be actuated, causing an electromagnetic repulsion with a corresponding magnet underneath the zone 22, causing the zone 22 to raise upward. As another example, to cause zone 22 to vibrate, zone 22 may include a small motor configured to rotate an unbalanced weight, whereby activation of the motor causes the zone 22 to vibrate. Other examples will be omitted, because one of ordinary skill in the art will know how to cause an object (such as zones 22-32) to physically move in a desired way, utilizing, e.g., electromagnetic interactions, hydraulic interactions, pneumatic interactions, mechanical interactions, and so forth.

Alternatively or in addition, each tooth 8 may be individually capable of any of the features discussed with respect to zones 22-32. For example, each tooth 8 may include one or more lamps (which may or may not be differently colored), which may be independently illuminatable. Further, each tooth 8 may be capable of being independently mechanically moved in ways that will be apparent to one of ordinary skill in the art.

Stand 12 may comprise any hard material, preferably a metal or plastic. Base 4 may be capable of movement or rotation with respect to the stand 12, such as via swivels 14, or swivels 14 may be omitted. The device 2 may include a switch 20, such as an on-off switch, that provides an information input to the device 2.

Referring now to FIG. 4, a circuit 302 to be implemented in a device according to an embodiment of the present invention comprises a processor 304 having a memory 306 and a timer 334, an information input 308 connected to the processor 304, an information output 316 connected to the processor 304, and a power supply 324 configured to power the processor 304. The electrical connections shown may comprise common information or power transmitting wires, or may be wireless (e.g., utilizing radio waves, sound waves, infrared waves, and other known means). The information input 308 may include input buttons/switches 310, a microphone 312, and/or a toothbrush 314 comprising a feedback sensor. The information output 316 may include a speaker 318, a display 320, and/or one or more indication lamps 322. The power supply 324 may be any known power supply, such as a battery, an adapter for providing electrical power to the processor from a standard A/C outlet, and so forth. Processor 304 and memory 306 include any such processor and memory known in the art.

The processor 304 is connected to a zone 326 (of a model of a set of teeth) which may correspond to any of the zones 22-32 of FIG. 1, such as zone 22. For ease of explanation, the lower portion of zone 326 will correspond to the “inner” region of the corresponding zone of a human mouth, and the upper portion of zone 326 will correspond to the “outer” region of the corresponding zone of the human mouth.

The zone 326 comprises three teeth 328, 330, 332. Each tooth may comprise one or more lamps, such as five lamps—i.e., tooth 328 comprises lamps A1-A5, tooth 330 comprises lamps A6-A10, and tooth 332 comprises lamps A11-A15, in the configuration shown. Lamps A1-A15 may be colored the same or differently depending on the tooth 328-332 and/or location within the corresponding tooth 328-332. Lamps A1-A15 may comprise any lamps known, such as incandescent bulbs, light emitting diodes (LEDs), and so forth. In one embodiment, the teeth 328-332 are hollow and translucent, instead of transparent (e.g., they comprise a translucent plastic, a clouded glass, etc.), and lamps A1-A15 are located within the hollow spaces of the corresponding teeth 328-332, so that when a lamp is illuminated, it appears as if the corresponding region of the illuminated tooth is illuminated, instead of being able to see the actual illuminated lamp inside the tooth. For example, if lamp A6 is illuminated, a child will perceive illumination of the inner region of tooth 330.

The processor 304 is configured to illuminate lamps A1-A15 (and other lamps of other zones not shown) in a manner to provide instructions to a child, such as to indicate which zones and/or teeth should be brushed, flossed, and so forth. For example, assume that the processor 304 is configured to provide instructions to a child to perform the following tasks: a) brush the child's teeth corresponding to the inner region of zone 326; b) brush the child's teeth corresponding to the outer region of zone 326; c) brush the child's teeth corresponding to the flat or grinding region of zone 326; d) floss between the child's teeth corresponding to teeth 328 and 330; and e) floss between the child's teeth corresponding to teeth 330 and 332. For part a), the processor 304 will illuminate lamps A1, A6, and A11 to indicate this region to the child. The processor 304 may cause the lamps to blink (to help attract the child's attention) or to turn on and off in succession to indicate a motion (e.g., a brushing motion) along zone 326. For example, the processor 304 may light lamp A1, then extinguish lamp A1 and light lamp A6, then extinguish lamp A6 and light lamp A11, then extinguish lamp A11 and light lamp A1 (or lamp A6), and so forth.

For part b), the processor 304 will illuminate lamps A3, A8, and A13 to indicate this region to the child. These lamps may or may not be colored differently than lamps A1, A6, and A11, so as to indicate that a different region is to be brushed. (This includes an embodiment in which all of the actual lamps A1-A15 illuminate the same color, such as white, but teeth 328-332 comprise one or more differently colored translucent regions, whereby illumination of lamps A1-A15 actually perceived by the child is of different colors.) For part c), the processor 304 will illuminate lamps A2, A7, and A12 to indicate this region to the child. For part d), the processor 304 will illuminate lamps A5 and/or A9 to indicate to the child the area between teeth 328, 330. For part e), the processor 304 will illuminate lamps A10 and/or A14 to indicate to the child the area between teeth 330, 332. Of course, each tooth 328-332 may include more or fewer lamps than indicated, and may include them in locations different than shown. The processor 304 may indicate an entire tooth or zone by illuminating all lamps within the tooth or zone, respectively. Of course, one or more zones (e.g., 22-32 in FIG. 1) may be configured similarly to zone 326 of FIG. 4, so that the processor 304 may be configured to indicate different zones, different teeth, different regions of different zones or teeth, different brushing movements among different zones or teeth, and so forth, simply by differentially illuminating lamps corresponding to each of the respective zones and teeth.

The circuit 302 may be very simple in design, or may be very complex in its capabilities. For example, in a very simple design, each zone comprises one or a few same-colored lamps, and the processor 304 is configured to simply indicate (by illuminating) each zone 22-32 (FIG. 1) in succession, corresponding to a timing in which the child should brush her corresponding teeth. In a more complex design, the processor 304 is capable of differentially indicating any of the following: different teeth, different regions of each zone, brushing motions, flossing regions between adjacent teeth, and so forth. One of ordinary skill in the art will understand how to cause processor 304, utilizing a program stored in memory 306, to illuminate lamps A1-A15 in a desired manner, consistent with the embodiments disclosed herein. One or more such lamps may also be located in or around the tongue 10 (FIG. 1), gum region 36, and so forth, and controllable by the processor 304. Thus, the processor 304 may be configured to indicate any of the zones, regions of the zones, individual teeth, flossing regions between adjacent teeth, the tongue, and the gum region, to help the child to identify and brush/floss the corresponding parts of her mouth indicated by the processor 304.

Alternatively or in addition, reference numbers A1-A15 may refer to sensors. For example, sensors A1-A15 may be sensitive to a pressure or contact with a toothbrush or other object. The sensors A1-A15 may therefore be configured to provide a feedback input into processor 304. The processor 304 may be configured to utilize this input to adjust its output (e.g., output to information output 316 or via control of lamps A1-A15) based at least in part on the input. For example, a child may be instructed by verbal instructions relayed by the processor 304 via speaker 322 to brush the inner region of zone 326 on the device. The child then begins brushing the zone 326 of the device, but (as many children often do) focuses primarily on the grinding region of the teeth 328-332. The sensors A2, A7, A12 will indicate a pressure greater than sensors A1, A6, A11, which information is fed to the processor 304, causing the processor 304 to instruct the child via speaker 322 to focus more on the inner region, thus providing feedback instructions to the child. As the child begins brushing more on the inner region of the zone 326, the processor 304 may be configured to praise the child by reproducing a human voice via speaker 322, such as “Way to go!” or “Now you're getting it!”

In one embodiment, button 310 includes an on-off switch (such as switch 20 in FIG. 1). The memory 306 stores a program to be executed by processor 304, as well as sound information to be relayed to the child via speaker 322. When the switch is turned on, the processor 304 is configured to make an announcement, such as, “Ready, set, brush!” (which may be a sound file representing a human voice stored in memory 306, and reproduced by processor 304 via speaker 322). Then, the processor 304 proceeds to indicate (by any method described herein, such as by illumination of lamps, physical movement, etc.) a first zone, such as zone 22 in FIG. 1. The processor 304 continues to indicate the first zone for a predetermined time, as measured by the timer 334, which may be between approximately 20 and 40 seconds, and preferably between approximately 30 and 35 seconds, and preferably about 33 seconds. In the meantime, the processor 304 may indicate a brushing motion, or may indicate each of the inner, outer, and grinding regions of the first zone in succession (such as for about 11 seconds each), or may indicate individual teeth within the zone, and so forth, as discussed previously. Further, the processor 304 may also accordingly instruct the child via sounds stored in the memory 306 and relayed via speaker 322, such as by relaying, “Start with the Green Zone” (if, e.g., the first zone is colored green or if lamps in the first zone are illuminated green) . . . “Make sure you brush all around and get all spots in the Green Zone” . . . and so forth. In other words, the processor 304 may reproduce sounds via speaker 322 that correspond to verbal instructions to brush in the manner corresponding to the indication of the first zone. The sounds may also be music, such as well-known nursery rhymes/songs, popular music, and so forth, that help to keep the child's attention. The instructions themselves may be embedded in the lyrics to the song(s).

After the predetermined time, the processor 304 stops indicating the first zone and begins indicating a second zone (such as zone 24 in FIG. 1), and the process continues. In a similar way, all zones (e.g., 22-32) of the model of the set of teeth are indicated, so that if the child has followed the instructions and/or indications provided by the device, the child will have properly brushed all of her teeth.

Next, in an embodiment, the processor 304 instructs the child to floss her teeth, such as by providing verbal instructions in a manner similar to that discussed, and indicating the gaps between adjacent teeth, e.g., by illuminating flossing lamps in adjacent teeth (as discussed with respect to FIG. 4). In an embodiment, the processor 304 may instruct the child to brush her tongue by indicating the tongue 10 (FIG. 1) by providing verbal instructions and by illuminating a lamp(s) corresponding to the tongue 10. Each of these events may be timed by timer 334 to as to cause the child to brush/floss each part of her mouth for the proper amount of time. In an embodiment, the processor 304 may instruct the child to rinse or gargle with mouthwash by providing verbal instructions.

Any of the instructions discussed above that are provided verbally via reproduction of sounds stored in memory 306 via processor 304 and speaker 322 may in addition or alternatively be given to a child via other information outputs, such as a display 320 or lamps 318. For example, the display may be an LCD screen on which is displayed the instruction, “Now brush your teeth in the Green Zone,” etc. or may include one or more corresponding icons or symbols. The latter may be preferred because many young children are not proficient at reading. So, e.g., the display 320 may be configured to display one of several symbols, such as a brush symbol, a floss symbol, and a mouthwash symbol, based on an instruction from the processor 304. The child will then know it is time to brush her teeth by seeing the “brush” symbol, and she will know what zone or region in her mouth to brush by looking at the model of the set of teeth on the device to determine which teeth or zones are being indicated. Then, she will know it is time to floss by seeing the “floss” symbol and by looking at the model to determine between which pairs of adjacent teeth she should floss, and so forth. Instead of a display 320, a simple series of indication lamps 318 may be used. For example, for the three activities mentioned (brush, floss, mouthwash gargle), the activities may be listed (in word or symbol form), each next to an indicator lamp 318. The indicator lamp 318 corresponding to the instructed activity may then be illuminated by the processor 304. Any other known means or method of providing instructions to a child by information output 316 is within the scope of the present invention.

At the end of the program or oral hygiene demonstration, the processor 304 may be configured to indicate (where the indication could be in the form of a human voice reproduction via speaker 322, a “win” lamp illumination via lamp 318, a display of a message on display 320, and so forth) to the child that the child has won a prize. For example, the processor 304 may indicate that the child has won a tangible prize, such as a small toy from the child's parent or a hug from the child's parent or a “get out of a chore free” prize, and so forth. Any conceivable prize that a child may value is within the scope of the present invention. Further, in one embodiment, the prize is offered only after three or more successful completions of the oral hygiene demonstration, or may be offered randomly. Thus, for instance, the child may know that “every once in a while” (e.g., randomly), the “prize lamp” (e.g., a lamp 318) may illuminate after the successful completion of a demonstration, entitling the child to a prize. Thus, the child becomes motivated to use the device 2 and to follow its instructions and demonstration, for the hope that at the end she will be rewarded with a prize (even though she knows that the prize is offered only every three demonstrations or randomly, etc.). Further, the prize may be intangible, such as winning “first place,” “rank of toothbrushing lieutenant,” “black belt toothbrusher,” scoring additional points in a fictitious game (such as two additional points in a fictitious basketball game against the “Cavities”), and so forth. Each time (or only some times, as discussed) that the child successfully completes her required oral hygiene via instructions from the device 2, the processor 304 may indicate to the child that she has increased her status, rank, or level, a means of positive feedback that will entire the child to continue using the device 2 to effectively promote her oral hygiene.

Various forms of information may be input via information input 308. For example, as discussed with reference to sensors A1-A15, other forms of feedback may be input into the processor 304 to help focus the device's demonstration on the areas in which the child needs the most help, and the instructions/demonstration/output of the processor 304 may be altered and/or chosen based at least in part on this feedback information. For example, the toothbrush 314 (which may correspond to toothbrush 34 in FIG. 1) may include a sensor configured to sense an aspect of a toothbrushing by the child, such as location, pressure, duration, toothbrush orientation, brushing stroke/movement, and so forth. This information may be fed back into the processor 304, wherein the demonstration/instructions provided by the processor 304 are altered or chosen based at least on part on this feedback information.

Processor 304 may be capable of operation in several modes, such as “normal demonstration,” “brushing only,” “flossing only,” “rinsing only,” “random mode” (wherein the zones and/or teeth indicated by the device 2 are not necessarily in a predetermined order or succession, and may be indicated in a random order to as to keep the child engaged and interested), “game mode” (wherein the device 2 may be configured to allow the child to play a game, via information input by the child via information input 308 and information output to the child via information output 316, which game may or may not be related to or occurring during an oral hygiene demonstration, which game may include any game known in the art) “song mode” (wherein the device 2 may be configured to play one or more songs, such as nursery rhymes or popular music, etc., and may include a sing-along function wherein the child is incited to sing along with the song at one or more times, which song may or may not be related to or occurring during an oral hygiene demonstration) and so forth, including any combination of these.

The desired mode may be selected by the parent or child via input buttons 310 and/or microphone 312, which may be used to input verbal information/commands that the processor 304 is configured to interpret into commands via voice recognition software stored in memory 306. Voice recognition software is well known and will not be further described here.

Further, the processor 304 may be configured to personalize the instructions/demonstration of the device 2 directly to the child who may be using the device 2. For example, the parent may enter the child's name (and/or other information, such as the child's gender, age, interests, parents' names, and so forth) via buttons 310 (which may include a touchpad or keyboard), or (more preferably) via microphone 312, wherein the parent records his voice into memory 306, which voice sound may be saved and reproduced at a later time via speaker 322. For example, the parent may speak “Danielle” into the microphone 312 while the processor 304 is configured to record the sound into memory 306. Then, when the parent causes the device 2 to execute an oral hygiene demonstration (such as by turning the device on via a switch 310, and/or by indicating a desired mode via a switch 310 and/or voice entered and recognized by the processor 304 via microphone 312), the processor 304 may create a verbal message to the child, such as, “OK, Danielle, it's time to brush your-teeth! Are you ready? Get set, go!” The processor 304 may then proceed to provide the instructions to the child via information output 316 and by indicating the various zones and/or teeth to be brushed as explained with reference to FIG. 4.

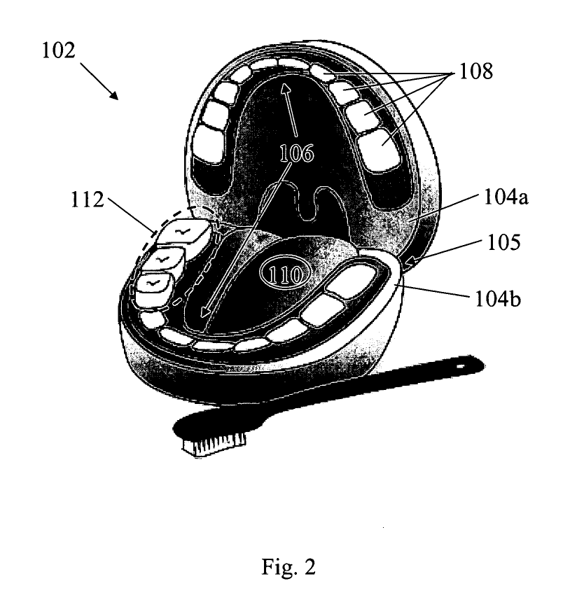

Referring now to FIG. 2, another device 102 according to the present invention comprises a base having an upper portion 104a and a lower portion 104b hingedly connected to the upper portion 104a via a hinge 105, and a model 106 of a set of teeth 108 and a tongue 110 connected to the base 104a, 104b. The set of teeth 108 may be divided into a plurality of subsets or zones, such as zone 112, corresponding to recommended toothbrushing zones of a child's teeth. In FIG. 2, the zones may be indicated by the processor 304 by protruding the zones from the base 104a, 104b, at the designated time. For example, as shown in FIG. 2, all teeth 108 are substantially flush with the base 104a, 104b, except the teeth 108 in zone 112, which are shown raised above the surrounding lower portion 104b, to indicate to the child to brush either the zone 112 or to brush the child's teeth corresponding to the zone. The zone 112 may be mechanically raised by any means discussed or known in the art, and may include a simple spring-loaded mechanical apparatus and/or an electromagnetic actuator or solenoid, etc. After the zone 112 has been raised for the predetermined time (which could be changed, e.g., by a parent via instructions provided through information input 308), the processor 304 causes the zone 112 to lower back down to be flush with the lower portion 104b, and a next zone (where “next” may refer to a subsequent zone in a predetermined order, or a randomly chosen zone in a random mode of processor 304) is raised to indicate to the child to brush the zone or brush her teeth corresponding to the zone.

The zones and/or teeth may be differently colored for easy identification and indication to the child. Alternatively or in addition, the zones and/or teeth may include lamps as discussed with reference to FIG. 4 (that may or may not be differently colored according to teeth, zones, and/or regions of zones) which may be illuminated by processor 304 in a manner to help the child to effectively promote her oral hygiene.

The lower portion 104b and upper portion 104a are preferably hinged so that the device 102 may be opened and closed in a manner similar to a human mouth. Further, on-off switch 310 (FIG. 4) may be incorporated into the base 104a, 104b in such a manner that opening and closing the device 102 causes the device 102 to turn on and off, respectively. For example, the device 102 may be a small, travel-size device that is carried by a child in a closed configuration. When the device 102 is opened, the processor 304 may begin the demonstration routine. For example, it may automatically reproduce a human voice saying, “OK, Danielle, time to brush! Start with the Yellow Zone. Brush on the inside for 10 seconds . . . 9 . . . 8 . . . 7 . . . 6 . . . 5 . . . 4 . . . 3 . . . 2 . . . 1 . . . OK, now move to the outside of the Yellow Zone for 10 seconds . . . ” . . . and the process may continue for the various regions of the zones, and may move from one zone to the next. The processor 304 may then instruct the child to brush her tongue, floss, rinse with mouthwash, and so forth, and may indicate that the child has won a prize, or may otherwise provide a positive reinforcement to the child to encourage her to continue using the device 102 on a regular basis. Of course, in a simpler design, the device 102 may simply indicate (e.g., by physical movement or illumination) each of six zones in succession for a predetermined time each, and may automatically turn off after the demonstration is successfully completed.

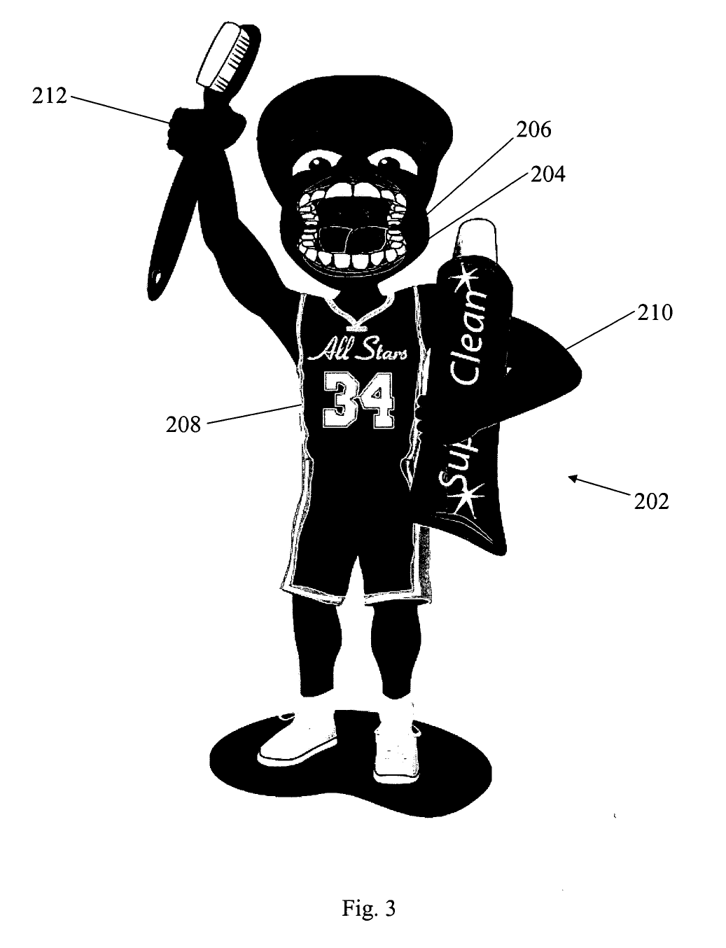

Referring now to FIG. 3, another device 202 according to the present invention comprises a base 204 (which may correspond to the base 4 in FIG. 1) and a frame 206 to which the base 204 is attached. The frame 206 preferably includes the shape and/or appearance of a human face, particularly that of an athlete or other themed character (e.g., a rock star), and may include a body portion 208, which may have the appearance of a human body corresponding to the appearance of the human face, a toothpaste holder 210, and a toothbrush holder 212.

The indicator of the present invention may include any indicator known in the art. For example, lamps (e.g., A1-A15 in FIG. 4) and physical motion (e.g., of zone 112 in FIG. 2) may be used to indicate one or more zones or teeth. As another example, but not to limit the present invention, the indicator may comprise a lamp configured to provide a focused illumination on the model (such as a laser light or a lamp that has been designed to provide a focused beam by reflection (e.g., a parabolic reflector) and/or refraction (e.g., a converging lens)), and an actuator configured to aim the focused illumination from one zone or subset of teeth to another based at least in part on an instruction received from the processor 304. For example, the actuator could be an electromagnetic actuator connected to the focused lamp that is designed to aim the lamp's focus wherever the processor 304 instructs it to.

In another embodiment, the processor 304 may be configured to execute various aspects or modes of the demonstration depending on a time input from the clock/timer 334. For example, while a child should brush her teeth at least twice per day, she should probably only floss once per day. Therefore, the processor 304 may be configured to provide the flossing instruction/indication only once per 24 hour period, etc.

In another embodiment, the device 2 is substantially waterproof. Further, a method according to the present invention may include encouraging or inciting a child to brush the set of teeth (8 in FIG. 1) on the actual device 2 so as to help the child to learn how to properly brush her own teeth. The device 2 may indicate which zone(s) (22-32 in FIG. 1) and/or teeth 8 on the model 6 to brush by any means discussed, and may in addition instruct the child to brush her own teeth corresponding to the zones/teeth indicated by the processor 304. Thus, e.g., in FIG. 2, if the child is instructed to brush zone 112 of the device 102, by raising up zone 112 relative to the lower portion 104b, that the device 102 is waterproof will prevent water from the toothbrushing of the zone 112 from damaging any components, particularly electrical circuitry 302.

It has been discussed that the processor 304 may reproduce sounds corresponding to a voice providing instructions, as well as music, in conjunction with, during, before, after, or independently of an oral hygiene demonstration. However, alternatively or in addition, the processor 304 may reproduce sounds (e.g., “sound bites”) corresponding to or representing a voice providing any one of: a tip regarding oral hygiene (e.g., “Tommy Toothbrush reminds you to always brush down to your gums.”); a fact, particularly an interesting “fin fact,” regarding a human mouth (e.g., “Did you know that your wisdom teeth may come in during your late 20's?”); a joke; and a story (e.g., an old fable or a tall tale). Any of these may provided throughout the course of the demonstration (e.g., a two-minute story) to maintain the child's interest. Further, for those items (e.g., a joke or a story with an interesting punchline) with particularly interesting endings, the ending may be saved until the very end of the demonstration as a prize or reward for successful completion of the oral hygiene demonstration. Further, because digital memory is so inexpensive today, memory 306 may be sufficiently large to store sufficiently many sound bites such that no two sound bites (e.g., stories, jokes, tips, fun facts, etc.) must be repeated by the device 2 over even a relatively long usage (e.g., one or more years) of the device 2. Of course, as discussed, the processor 304 may reproduce sounds corresponding to or representing a voice indicating that the child has won a prize. For example, referring to FIG. 3, where the frame 206 has the appearance of a basketball player, the processor 304 may provide a sound bite at the end of the demonstration indicating that the child has just scored another two points against the opponent, or has won a game against the opponent, and so forth.

In another embodiment, the device 2 may be sold with a video (e.g., DVD or VHS) that provides a video demonstration and/or instruction on proper methods for promoting oral hygiene. A parent may encourage the child to watch the video, and to subsequently utilize the device 2 to provide a demonstration to the child which includes indications of zones and/or teeth and/or regions in the device's model, and may include further instructions, information, sound bites, etc., provided by the information output 316. The child may be encouraged to brush her own teeth, floss, rinse with mouthwash, etc., according to instructions and information provided by both the video and the device 2.

The applicant also provides the following additional description and embodiments:

My Brushing Buddy™ (“MBB”) is an aid for kids who are learning to brush their teeth and need help remaining focused, covering all areas of the mouth. It will run the recommended ADA time of 2 minutes, directing the kids between each brushing zone by different colored lights. It will have a random play button as well to help with the monotony of teeth brushing. It may have a dental mold form that would open and then begin with the flashing zones, etc., and when you close the mouth it shuts off. It may have the form of a travel size for sleepovers, one with an instructional video, etc.

MBB is a fuin and educational tool that kids, ages 2-10, can use to help learn to brush their teeth. It works by showing kids how, where and for how long to brush their teeth. It is because performing a thorough teeth brushing is both a learned fine motor skill and a focused task, MBB was created to provide the help needed to keep children on track so they wont quit or get “lost” before accomplishing this important skill.

MBB can be made in several forms. One is on a stand, appropriately sized for a bathroom counter top, with an upper and lower outline of the teeth, resembling the open mouth of a child between the ages of 2-10 years old (20 total teeth). The teeth will look identical to human teeth (anatomically correct) but will be raised off of the plastic plate for better viewing. They also may have an arrowed circle graphic reminding to brush in the circular motion or in the “Bass” vibration method (circular is a preferred choice as not many kids can easily create a vibration with their bristles). They will be divided (by color) into six brushing zones. In the middle of the teeth (where the tongue would be) is a speaker for sound, and potentially a logo. There might also be some type of illustration of a tongue and uvula. On the back there is a cutout so MBB could hang by nail on the wall and the battery door. On either side of the stand, would be a toothbrush(s) and toothpaste(s) holder. On the base or side there will be an on/off switch. When the switch is activated, a voice will command a “ready set brush!” type of signal accompanied by a catchy tune to begin. The voice may also prompt throughout the brushing time.

For the length of the ADA recommended brushing time (2 minutes) MBB will cycle through each “brushing zone.” There are a total of 6 brushing zones, each highlighted in different colors. Each zone will light up for approx. 33 seconds to direct the children through a thorough cleaning of their entire mouth. Within the 33 seconds, it will be further broken down into 11 second increments where the different portions of the teeth in that zone are lit. For example, the inside of the teeth will light directing the child to brush inside for 11 seconds, then the outside of those same teeth will light (inside light goes off when outside light clicks on) for 11 seconds, then the whole of the teeth will light for 11 seconds. The next zone will then light up directing the child to move on. To help keep the idea fresh, and break the monotony of daily brushing, there would be a “random brush” mode. When in the mode the six brushing stations would still cycle through; they would just do so at random making it a game for the child to follow along, thus keeping them engaged and focused night after night.

MBB may incorporate the tongue into the brushing schedule by shortening each zone by one second and having an illustrated tongue light up for 6 seconds. An additional feature would be a “flossing mode.” It would direct the children in between each of their teeth to floss through their entire mouth. Once again, MBB will keep the child from losing their place as they go by lighting up the space in between each tooth. Possibly the arrowed circle graphic that is in the middle of two teeth (or half on one tooth and half on the other) will light up during the brushing mode.

Another form would be in the shape of an actual dental mold. It would open up similar to how a human mouth opens up. It would be mounted onto a somewhat flat oval plate that would be sleek and thin to allow for drawer storage. Within the plate would be battery storage, the mechanics, etc. MBB would essentially work the same as the other form(s) mentioned.

Another form is a “travel size” for slumber parties and long distance travel, approximately the size of a women's large cosmetic compact case. It may have a hinged door to open up to see the teeth flat but the song and direction may still be obtained.

Another form would cater to the sports fans and would be an athlete, say for example Shaquille Oneill. A model of the Shaq would be in a standing position with his arms overhead (like a champion stands) and like bobble heads, his mouth would be large and wide open with the same model of colored MBB teeth. In his hands would be in one a toothbrush holder and in another a toothpaste as if they were trays. The same modes would apply to this form as well.

With all forms a “how to video” (VHS or DVD) can accompany each MBB to demonstrate proper teeth brushing and MBB care. This video would ideally be performed by the character of the company who licenses the MBB. Also for instruction and/or instructional reminders, on the front somewhere may be included a graphic to help describe the brushing circular style, or in the case of flossing, a picture of a tooth with the floss down beside it.

An MBB caddy can also accommodate in addition to the toothpaste and toothbrush, a rinse cup and floss bay.

MBB can have instead of catchy tunes, jokes that play as the child brushes. One way to do that would be to start with a joke question and when the 2 minutes are up, the punch line is given. Some may view that as a fuin little reward.

Another form of MBB can be held up by suction cups that would go directly onto the bathroom mirror, for homes where space is an issue.

There may be an option to have a timer and sound effects that would be for one minute in length, to be used when swishing a fluoride rinse or mouthwash. Dentists recommend one minute for swishing, once a day for children 6 years and older as proper oral care. Fluoride may be only recommended for children 6 and up.

There could be a version for a little girl and alternatively for a little boy. For a boy, a sideways ball cap, etc., could be placed on a model of a boy's face. Additional space could house the buttons for random, floss, etc., modes. It would just look more like something standing on the counter as you stare at it.

To differentiate the brush zones, the teeth could raise up as a group or zone. So for example the back right teeth would stand, if you will, when it is their turn to be brushed. This would also be helpful when using the MBB as a model for kids to learn to brush on.

When the fluoride rinse begins a joke could be told for example: why did the dog cross the road? As the minute goes by the child could be contemplating that and then towards the end of the minute, say at the 50 second mark, it would prompt: “Why did the dog cross the road?” . . . then the punch line “to get to the barking lot!” So it would help get the kid over that hump. It could also work with dental trivia. As the minute goes by it could play little bits of trivia . . . what animal has the largest or most teeth, etc.

And with the sports figure, maybe a basketball hoop could be incorporated somehow as a rinse cup or toothpaste holder. The voice may prompt with rewards like the slam dunk, crowd cheers. For example, “Sugar bugs 0, Brushing all stars 12,” and then the next time the timer plays it would know to increase the score by two.

Further, any use of the word “mouthwash” herein preferably refers to a fluoride rinse, but may refer to a general breath-freshening and/or cavity fighting and/or oral cleansing rinse. Further, the device described herein may in one embodiment instruct the child to rinse and may also time the child while rinsing, and may instruct the child to stop rinsing after a predetermined rinsing time. The device may provide sound bites during this time, such as music, a representation of a human voice telling a joke or story, etc. The predetermined time may be between approximately 20 and 80 seconds, preferably between approximately 30 and 60 seconds. In another embodiment of the device shown in FIG. 3 (or any other drawing), a cup holder may be present.

Any combination of features, designs, aspects, and embodiments described herein for which combination is physically possible is within the scope of the present invention. Including every possible permutation and combination of features, aspects, etc., of the present invention would involve an unnecessarily and excessively long application. Therefore, the present invention includes such combinations, permutations, mixing and matching of features, aspects, etc., to the extent physically possible.

Most of the embodiments described herein have represented simple versions for clarity of explanation. As understood by one of ordinary skill in the art, many of the features and/or aspects of the embodiments described herein may be “mixed and matched” to the extent physically possible to satisfy individual design requirements. Further, variations on the above discussed embodiments are within the scope of the present invention.

1. A device for promoting effective oral hygiene by a child, comprising:
a base;
a model of a set of teeth connected to the base;
an indicator connected to at least one of the model and the base and configured to indicate a first subset of said set of teeth; and
a processor connected to the indicator and configured to cause the indicator to indicate said first subset to thereby instruct said child to brush the child's teeth corresponding to said first subset, and to cause the indicator to subsequently indicate a second subset of said set of teeth, different from said first set, to thereby instruct said child to brush the child's teeth corresponding to said second subset,
wherein said first subset corresponds to a first recommended tooth-brushing zone of a mouth of said child and said second subset corresponds to a second recommended tooth-brushing zone of said mouth of said child.

2. The device as claimed in claim 1, further comprising a frame to which the base is connected, wherein the frame has a shape of a human head and has a facial appearance representing a face of a human athlete.

3. The device as claimed in claim 1, further comprising a microphone connected to the processor, wherein the processor is programmed to recognize a voice sound input via the microphone as an instruction to the processor.

4. The device as claimed in claim 1, further comprising an information output connected to the processor, said information output comprising at least one of a display, a lamp, and a speaker, wherein said processor is configured to, after a successful completion of an oral hygiene demonstration by said device, indicate to the child via the information output that the child has earned a prize.

5. The device as claimed in claim 1, wherein the processor is configured to cause the indicator to indicate spaces between pairs of adjacent teeth of said set of teeth to thereby instruct the child to floss between the child's teeth corresponding to said spaces.

6. The device as claimed in claim 1, further comprising a tongue model connected to the base, wherein the processor is configured to cause the indicator to indicate said tongue model to thereby instruct said child to brush the child's tongue.

7. The device as claimed in claim 1, further comprising a speaker connected to the processor,
wherein the processor is programmed to create sounds via the speaker, and
wherein said sounds comprise a representation of a voice providing at least one of: a tip regarding oral hygiene; a fact regarding a human mouth; a joke; and a story.

8. The device as claimed in claim 1, further comprising a speaker connected to the processor,
wherein the processor is programmed to create sounds via the speaker,
wherein the device further comprises an input connected to the processor and configured to allow a user to input a personalization into the processor, and
wherein the sounds are personalized with respect to said child.

9. The device as claimed in claim 1, further comprising a speaker connected to the processor,
wherein the processor is programmed to create sounds via the speaker,
wherein said sounds comprise a representation of a voice providing instructions to a child regarding effective oral hygiene, and
wherein at least one of a) and b) is true:
a) the device further comprises a toothbrush remotely connected to the processor, wherein the toothbrush is configured to provide a feedback signal to the processor, and wherein the instructions are selected based at least in part on the feedback signal; and
b) the device further comprises at least one sensor connected to the processor and the first subset, wherein the at least one sensor is configured to convert a tooth-brushing of the first subset into a feedback signal to the processor, and wherein the instructions are selected based at least in part on the feedback signal.

10. The device as claimed in claim 1, further comprising a speaker connected to the processor, wherein the processor is programmed to create sounds via the speaker, wherein the sounds comprise a representation of a voice providing instructions to a child regarding rinsing with mouthwash.

11. The device as claimed in claim 1, wherein the processor is configured to cause the indicator to indicate a brushing movement within said first subset, and
wherein the indicator comprises a plurality of lamps, independently illuminatable by said processor, which when illuminated successively indicate a brushing movement within the first subset.

12. The device as claimed in claim 1, wherein the base is hinged to allow said model of teeth to close in a manner corresponding to a closing a human mouth.

13. The device as claimed in claim 1, wherein the indicator is configured to indicate the first subset of said set of teeth at least in part by a mechanical movement of said first subset.

14. The device as claimed in claim 1, wherein the processor is configured to cause the indicator to indicate, at different times, exactly three distinct subsets of an upper region of said set of teeth and exactly three distinct subsets of a lower region of said set of teeth, and wherein each of said distinct subsets is colored differently.

15. The device as claimed in claim 1, wherein the processor is capable of operation in at least a normal mode and a random mode,
wherein in the normal mode the processor is configured to indicate said distinct subsets in a predetermined order, and
wherein the random mode the processor is configured to indicate said distinct subsets in a random order.

16. The device as claimed in claim 1, wherein the set of teeth protrude from the base to represent actual human teeth protruding from gums.

17. A method for promoting effective oral hygiene by a child, comprising:
providing the device as claimed in claim 1; and
encouraging a child to operate the device,
wherein the device is configured to provide a positive reinforcement to said child after a successful completion of an oral hygiene demonstration by the device.

18. A method for promoting effective oral hygiene by a child, comprising:
providing the device as claimed in claim 1; and
encouraging a child to operate the device,
wherein the device is configured to execute an oral hygiene demonstration that includes at least one of the following: instructing the child to rinse with mouthwash; instructing the child to floss; and instructing the child to brush the child's tongue.

19. A method for promoting effective oral hygiene by a child, comprising:
providing the device as claimed in claim 1; and
encouraging a child to operate the device; and
encouraging the child to brush the set of teeth.

20. A method for promoting effective oral hygiene by a child, comprising:
providing the device as claimed in claim 1;
providing a video for instructing a child on effective oral hygiene;
showing the video to the child;
encouraging the child to operate the device; and
encouraging the child to execute effective oral hygiene based on instructions from both the video and the device.
